(19) United States
(12) Patent Application Publication
(10) Pub. No.: US 2002/0012149 A1
(43) Pub. Date: Jan. 31, 2002

(54) Optical communication device and its control method

(76) Inventors: Takashi Yamanaka, Chiba-shi (JP); Masao Kasuga, Chiba-shi (JP); Akihiro Iino, Chiba-shi (JP); Kenji Suzuki, Chiba-shi (JP); Tomohiro Shimada, Chiba-shi (JP)

Correspondence Address: ADAMS & WILKS, 31st Floor, 50 Broadway, New York, NY, 10004, US

(21) Appl. No.: 09/910,108

(22) Filed: Jul. 20, 2001

(30) Foreign Application Priority Data
Jul. 27, 2000 (JP) 2000-227380

(51) Int. Cl. H04B 10/00

(52) U.S. Cl. 359/172; 359/154

(57) ABSTRACT

A compact multifunctional optical communication device and its control method is provided which having good responsibility. An optical communication device has an input section and an output section for propagating a light beam through a space; plural optical parts movable to an interrupting position of the light beam between the input section and the output section, and arranged in a series direction with the light beam; driving means for separately driving these optical parts; and driving control means for controlling an operation of this driving means.

### BACKGROUND OF THE INVENTION

1. Technical Field of the Invention

The present invention relates to an optical communication device used in an optical network of e.g., a high density light wavelength multiplex system, and more particularly relates to a compact multifunctional optical communication device.

2. Description of the Related Art

In recent years, a communication transfer system tends to be switched to a system using an optical fiber as the Internet, etc. have rapidly spread. Further, a WDM (Wavelength Division Multiplexing) transmission system using optical multiplex conversion tends to be adopted so as to further increase the density of a transmission capacity. An optical control communication module for synthesizing/dividing, switching and damping an optical signal different in wavelength, etc. is indispensable to the adoption of the WDM system.

For example, there are light wavelength variable filters disclosed in Japanese Patent Laid-Open Nos. 257068/1993, 281480/1993 and 198936/1995 as a conventional optical control communication module.

However, with respect to a filter main body used in these light wavelength variable filters, one filter has a light transmitting distribution and a transmitting wavelength is switched by sliding the filter main body with respect to a light beam. Accordingly, productivity of the filter main body is low and it takes cost. Further, when the wavelength is greatly different in the switching of the transmitting wavelength, a slide distance of the filter is lengthened so that responsibility becomes worse. Further, it is not easy to make the filter main body compact since the filter main body has a size to a certain extent.

Further, each optical control communication module has a single function. Therefore, when it is necessary for the optical communication device to have plural functions, it is necessary to use plural optical control communication modules. Namely, the optical communication device is large-sized.

### SUMMARY OF THE INVENTION

An object of the present invention is to provide a compact multifunctional optical communication device having good responsibility, and a control method of this optical communication device.

To solve the above problem, an optical communication device in the present invention is characterized in that the optical communication device comprises an optical system for propagating a light beam through a space; plural optical parts movable to an interrupting position of the light beam within the space, and arranged in a series direction with the light beam; driving means for separately driving these optical parts; and driving control means for controlling an operation of this driving means. Accordingly, the optical communication device can be made compact by arranging the optical parts in series with the light beam.

Here, for example, the optical communication device is, Switch, Splitter, Combiler, Attenuator, Isolator, shutter, Terminator, Demultiplexer, multiplexer, Add-drop-module.

Also, the optical communication device is included the added Optical, Wavelength, and Polarization before there devices name (for example, Wavelength Switch, Wavelength Splitter, Wavelength Combiler, Optical Attenuator, Optical Isolator, Optical shutter, Optical Terminator, Optical Demultiplexer, Optical multiplexer, Optical Add-drop-module, etc.).

Moreover the optical communication device is included the combination of single function devices above.

Further, for example, the optical part is an optical filter constructed by a dielectric multilayer film, a lens, a prism, a reflecting plate, etc.

When two kinds or more of optical parts are arranged, the optical communication device can be set to be multifunctional while compactness is maintained.

Further, when two kinds or more of optical parts having different wavelength transmitting characteristics are included, light of a predetermined desirable wavelength can be transmitted by switching the optical parts arranged in an interrupting position of the light beam. Further, when two kinds or more of optical parts having different wavelength absorption characteristics are included, the light of a predetermined desirable wavelength can be absorbed by switching the optical parts arranged in the interrupting position of the light beam. Namely, the function of an optical filter can be provided to make a wavelength selection in the optical communication device by using such constructions.

When two kinds or more of optical parts having different transmitting light amount characteristics are included, a transmitting light amount can be adjusted by switching the optical parts arranged in the interrupting position of the light beam. Namely, the optical communication device can have a function for adjusting the transmitting light amount.

Further, when an optical part having optical path converting characteristics such as a prism, a mirror, etc. is included together with other optical parts (e.g., each of the above optical parts), an optical path can be converted to a predetermined desirable direction by changing an angle of the optical part having the optical path converting characteristics. Namely, the optical communication device can also have a function for converting the optical path.

Further, the optical communication device can have a backup function by further arranging one or more optical parts having the same optical characteristics in at least one kind of optical parts.

When plural driving means are arranged, it is necessary to widen a clearance of the optical parts such that front and rear optical parts and the driving means do not interfere with each other. However, when front and rear driving means with respect to the light beam are arranged in a zigzag shape between the same optical parts, the clearance of the optical parts can be narrowed. Namely, the optical communication device can be made further compact.

In this case, productivity at an assembly time is improved when moving optical members obtained by assembling the driving means into the optical parts are arranged such that the driving means is located between the same optical parts through the light beam.

For example, a piezoelectric actuator is used as the driving means. In this case, the driving means becomes compact and has high torque when a piezoelectric body for generating a stretching vibration, and a moving body frictionally driven by the stretching vibration generated by this piezoelectric body are arranged. Therefore, the optical communication device can be made further compact. More concretely, piezoelectric actuators of a rotating type and a direct acting type are used.

When the driving means is the piezoelectric actuator, the following construction can be used.

First, the control means may be constructed such that a preliminary signal is inputted to this control means before the driving. In this case, since the piezoelectric actuator is warmed up by the preliminary signal and has good responsibility, responsibility of the optical communication device can be improved.

Further, when the control means has a self-excited oscillating circuit, the piezoelectric actuator can be more efficiently driven.

Further, when a supporting member for movably supporting the optical part is arranged and the control means is arranged in this supporting member, space is effectively utilized and the optical communication device can be made compacter.

Further, when it is controlled in the above optical communication device such that the plural optical parts are simultaneously driven, a time required to switch the optical parts can be shortened. Namely, responsibility of the optical communication device can be improved.

### BRIEF DESCRIPTION OF THE DRAWINGS

FIG. 1 is a block diagram showing the construction of an optical communication device in a first embodiment mode of the present invention;

FIG. 2A is a sectional schematic view of the optical communication device of FIG. 1, and

FIG. 2B is a schematic plan view of this optical communication device;

FIG. 3 is a view for explaining the function of an optical filter as an optical part of FIG. 1;

FIG. 4 is a block diagram showing the construction of a moving optical member of FIG. 1;

FIG. 5 is a block diagram showing one example of a driving circuit of FIG. 1;

FIG. 6 is a view showing a main portion of an optical communication device in a second embodiment mode of the present invention;

FIG. 7 is a view showing the construction of an optical communication device in a third embodiment mode of the present invention wherein

FIG. 7A is a sectional schematic view of this construction, and

FIG. 7B is a schematic plan view of this construction;

FIG. 8 is a view showing the construction of an optical communication device in a fourth embodiment mode of the present invention wherein

FIG. 8A is a sectional schematic view of this construction, and

FIG. 8B is a schematic plan view of this construction;

FIG. 9 is a view showing the construction of an optical communication device in a fifth embodiment mode of the present invention wherein

FIG. 9A is a front view showing a main portion of this construction, and

FIG. 9B is a plan view of this construction.

### DETAILED DESCRIPTION OF PREFERRED EMBODIEMENTS

Embodiment 1

The schematic construction of an optical communication device in the present invention will first be explained by using block diagrams.

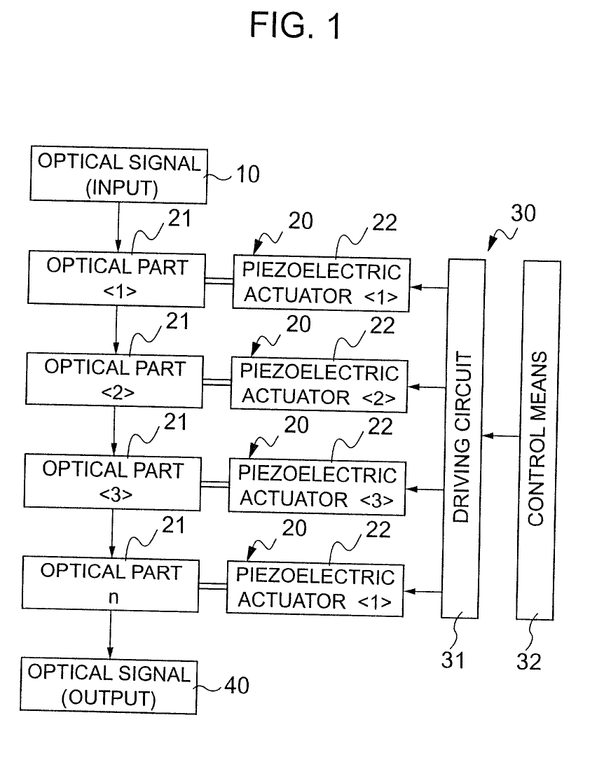

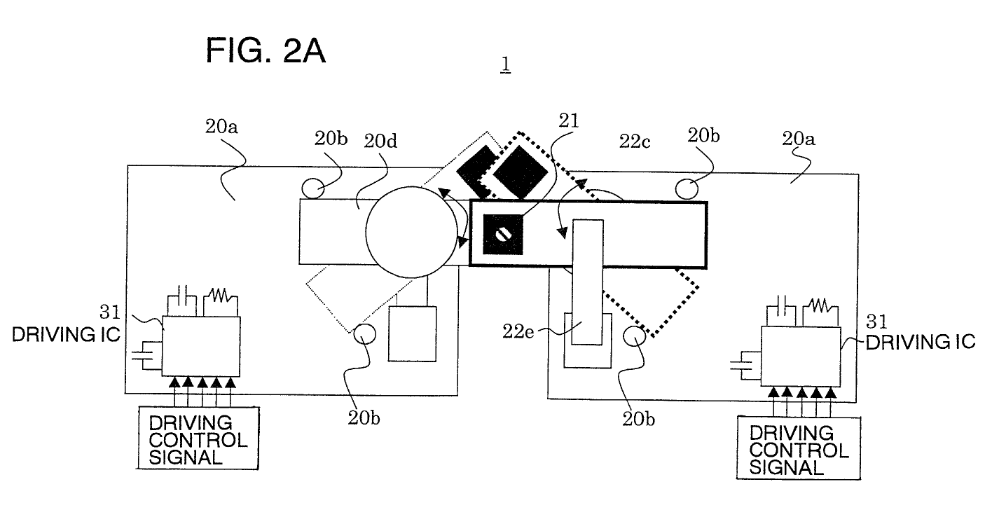

As shown in FIGS. 1 and 2A and 2B, an optical communication device 1 is schematically constructed by an input section 10 for inputting an optical signal, plural moving optical members 20 for controlling the optical signal inputted from the input section 10, a driving control means 30 for controlling an operation of each moving optical member 20, and an output section 40 for outputting the optical signal. Namely, in the optical communication device 1, the optical signal inputted from the input section 10 is controlled by the moving optical member 20, and is then outputted from the output section 40.

As shown in FIG. 2B, the moving optical members 20 are arranged in series and alternately with respect to a light beam 100 between the input section 10 and the output section 40.

As shown in FIG. 2B, the input section 10 has an optical fiber 10a and a lens 10b. The output section 40 similarly has an optical fiber 40a and a lens 40b. Thus, parallel a light beam 100 can be obtained between the input section 10 and the output section 40. Means for taking parallel the light beam 100 is not limited to the above. For example, A method for taking parallel a light beam may be also used by the optical fiber 40a, 40b which have a special worked side surface kind of aspherical for outputting optical signal like through parallel a space.

The moving optical member 20 is constructed by an optical part 21 and a piezoelectric actuator 22, and controls the optical signal by moving the optical part 21 by the piezoelectric actuator 22 until an interrupting position of the optical signal, or separating the optical part 21 from the interrupting position. As shown in FIG. 2A, the moving optical member 20 is attached to a side face of a supporting member 20a (not shown in FIG. 2B).

As shown in FIG. 2B, the side face of the supporting member 20a on an attaching side of the moving optical member 20 is univocally determined in accordance with on which side the moving optical member 20 is located with respect to the light beam 100. This side face of the supporting member 20a is opposed through the light beam 100. Thus, it is possible to narrow a required interval for arranging the moving optical member 20.

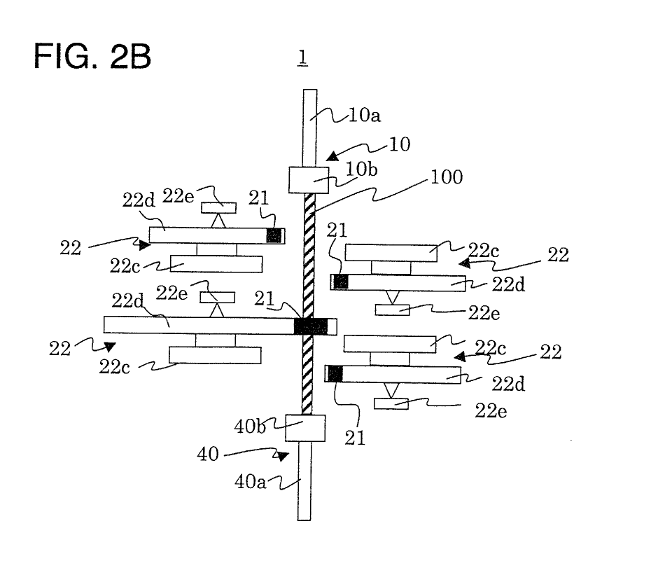

An optical filter for transmitting light of a specific wavelength (see FIG. 3A), an optical filter for absorbing light of a specific wavelength (see FIG. 3B), an optical filter for adjusting a transmitting light amount (see FIG. 3C), etc. are considered as the optical part 21, and the optical part 21 is constructed by a dielectric multilayer film.

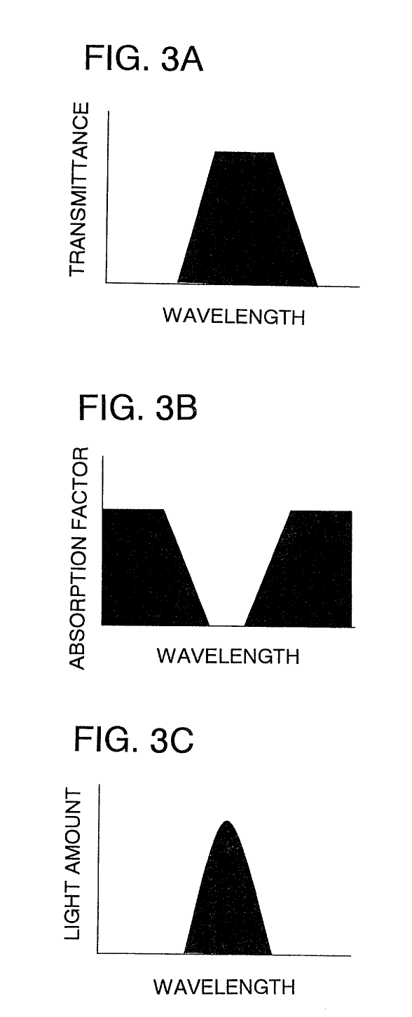

For example, the piezoelectric actuator 22 is a piezoelectric actuator of a rotating type. As illustrated in FIGS. 2 and 4, the piezoelectric actuator 22 is schematically constructed by a piezoelectric element 22b on a disc fixed onto a fixing base 22a, a vibrating body 22c arranged integrally with the piezoelectric element 22b, a moving body 22d mounted onto the vibrating body 22c, and a pressurizing means 22e for securing contact pressure of the vibrating body 22c and the moving body 22d. A bending vibration caused on an upper face of the piezoelectric element 22b is amplified by the vibrating body 11c, and is outputted as driving force from an unillustrated projection on the vibrating body 11c to the moving body 22d. The moving body 22d fixedly holds the optical part at its one end.

The moving body 22d of the piezoelectric actuator 22 is an integral object having a bar shape, and is rotated with a portion of the moving body 22d near its center as a rotating shaft. The moving body in the present invention may be also constructed by plural members in accordance with uses.

Two projections 20b are arranged on a side face of the supporting member 20a such that these projections 20b nip the other end of the moving body 22d on a rotating circular circumference at this other end. Namely, a rotating range of the moving body 22d is limited by the two projections 20b. One of the projections 20b is arranged such that the optical part 21 arranged at one end of the moving body 22d is located in an interrupting place of the light beam 100 near a side end of the supporting member 20a. The other of the projections 20b is arranged such that the moving body 22d and the optical part 21 are located in escaping positions as places not interfering with the light beam 100. Primary moment of the moving body 22d can be reduced by this structure.

Namely, all the moving optical members 20 have the same construction except for the optical part 21 so that productivity is increased. Further, all driving rotation directions in an interrupting case of the light beam are the same direction so that a control system using the driving control means 30 is simplified.

As shown in FIG. 1, the driving control means 30 is constructed by e.g., a driving circuit 31 and a control means 32.

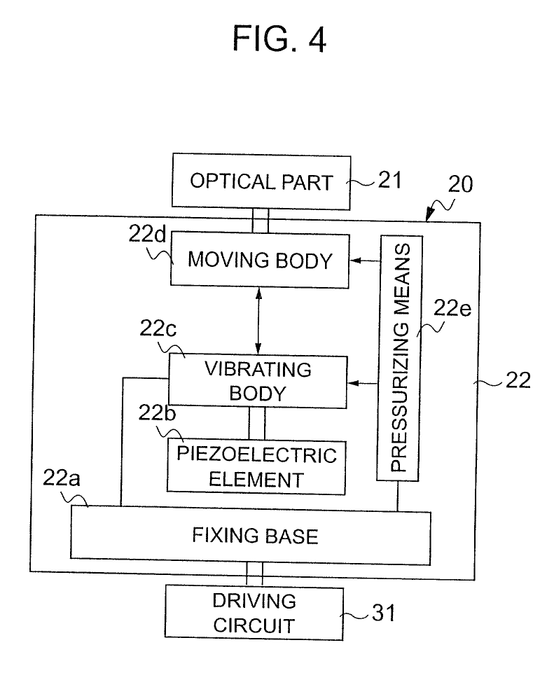

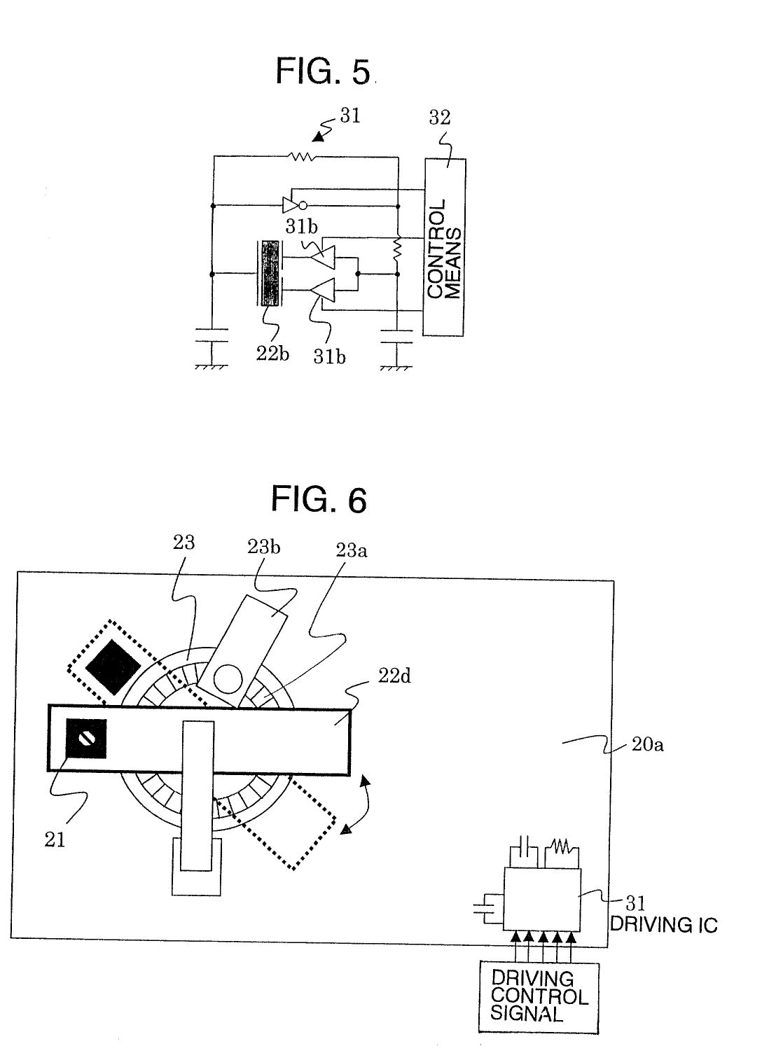

The driving circuit 31 is a well-known self-excited oscillating circuit exemplified in FIG. 5, and amplifies a periodic voltage variation between both faces caused by a piezoelectric vibration of the piezoelectric element 22b, and uses this periodic voltage variation as a driving signal of the piezoelectric element 22b itself. For example, the driving circuit 31 is constructed by an IC, and is attached to a side face of the supporting member 20a, preferably, the side face of the supporting member 20a on the attaching side of the moving optical member 20 with compactness as an object.

The operations of an inverting amplifier 31a and an amplifier 31b within the driving circuit 31 are controlled by the control means 32. Thus, an operation of the piezoelectric actuator 22 is controlled by the control means 32.

The control means 32 rotates and moves each optical part 21 by controlling the operation of the piezoelectric actuator 22. In this case, a new optical part 21 is arranged in the interrupting position of the light beam 100 to shorten a switching time, and the optical part 21 arranged in the interrupting position of the light beam 100 is simultaneously returned until the escaping position.

The control means 32 inputs a preliminary signal to the piezoelectric actuator 22 before the optical part 21 is rotated and moved by mainly driving the piezoelectric actuator 22. Since the preliminary signal is inputted to the piezoelectric actuator 22, the piezoelectric actuator 22 attains a warming-up state and responsibility at an inputting time of a driving signal for the main driving is improved.

The preliminary signal is constructed by a driving signal in a direction opposed to that in the main driving, and a driving signal small to such an extent that no moving body 22d is moved. In the former case, the moving body 22d is pressed against the projection 20b by driving force, and no moving body 22d is moved.

In accordance with the optical communication device 1 of the above construction, the optical part 21 arranged in the interrupting position of the light beam 100 can be suitably selected by suitably controlling the operation of each moving optical member 20. Accordingly, an optical filter function of the optical communication device 1 is switched.

Namely, the optical communication device 1 becomes an optical communication device able to switch the wavelength of output light of the output section 40 with good responsibility by using optical filters of plural kinds having different wavelength transmitting characteristics as the optical part 21.

The optical communication device 1 also becomes an optical communication device able to switch the wavelength of light removed from the output light from the output section 40 with good responsibility by using optical filters of plural kinds having different wavelength absorption characteristics as the optical part 21.

The optical communication device 1 also becomes an optical communication device able to change intensity of the output light from the output section 40 with good responsibility by using optical filters of plural kinds having different light absorption rates as the optical part 21.

Further, the optical communication device 1 becomes an optical communication device having a backup function by arranging a plurality of the same optical filters.

Since it is not necessary to use a variable type filter, productivity is improved and cost is reduced.

Further, a control state of the light beam 100 can be maintained without operating the piezoelectric actuator 22 by flowing an electric current through the piezoelectric actuator 22. Accordingly, consumed energy of the optical communication device 1 can be reduced.

Embodiment 2

An optical communication device 1 in a second embodiment mode of the present invention schematically has a construction similar to that of the optical communication device 1 in the first embodiment mode. However, in the construction of the optical communication device in this second embodiment mode, an encoder 23 is arranged without arranging the projection 20b in the moving optical member 20, and the control means 32 has a function for controlling an operation of the piezoelectric actuator 22 on the basis of detecting results from the encoder 23.

The encoder 23 is constructed bya slit 23a rotated together with the moving body 22d and a well-known rotating amount detector 23b of an optical type for detecting a rotating amount of the slit 23a. Detecting results of the rotating amount detector 23b are transmitted to the control means 32.

In accordance with this embodiment mode, effects similar to those in the first embodiment mode are obtained, and an operation of the moving body 22d can be controlled such that this moving body 22d is set to an arbitrary angle. Further, there is no possibility of defects caused by contact of the projection 20b and the moving body 22d.

Embodiment 3

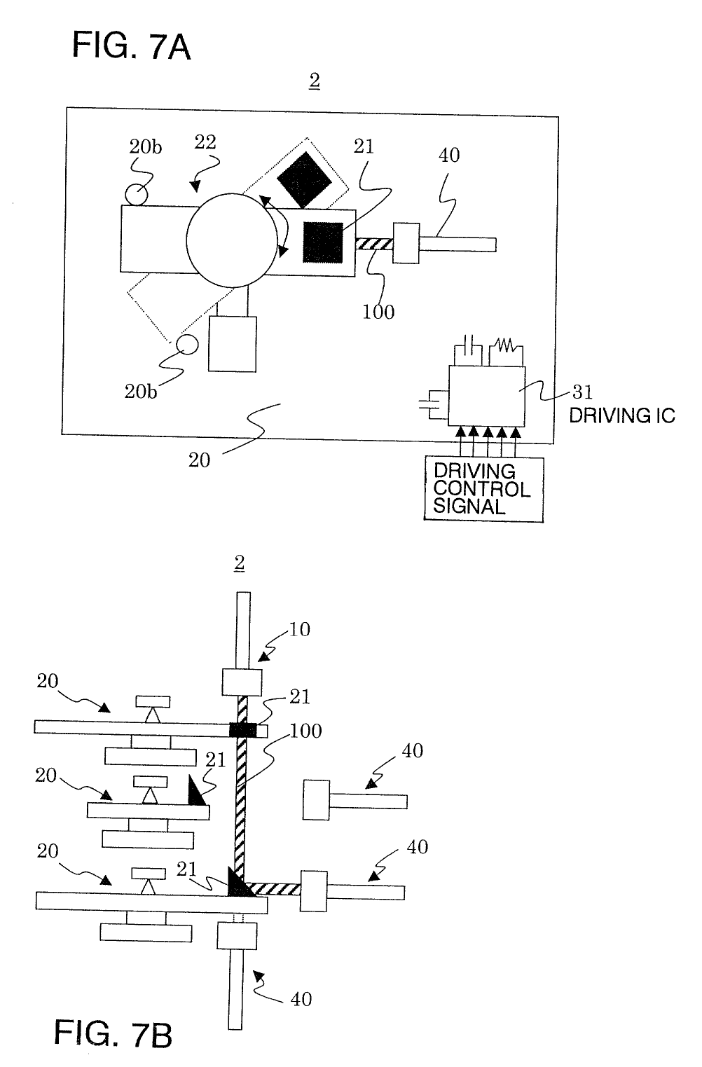

An optical communication device 2 in a third embodiment mode of the present invention schematically has a construction similar to that of the optical communication device 1. However, as shown in FIGS. 7A and 7B, a reflecting plate or a prism for bending a light beam 100 is adopted as at least one optical part 21 (final two parts in FIG. 7B), and an output section 40 with respect to the light beam 100 bent by the optical part 21 is added.

In accordance with the optical communication device 2, a position of the optical part 21 for bending the light beam 100 is set to an interrupting position of the light beam 100 and is separated from this interrupting position so that the output section 40 for emitting the light beam 100 is switched. Namely, the optical communication device 2 becomes a device of a composite type also having the function of an optical switching device while compactness is maintained.

Embodiment 4

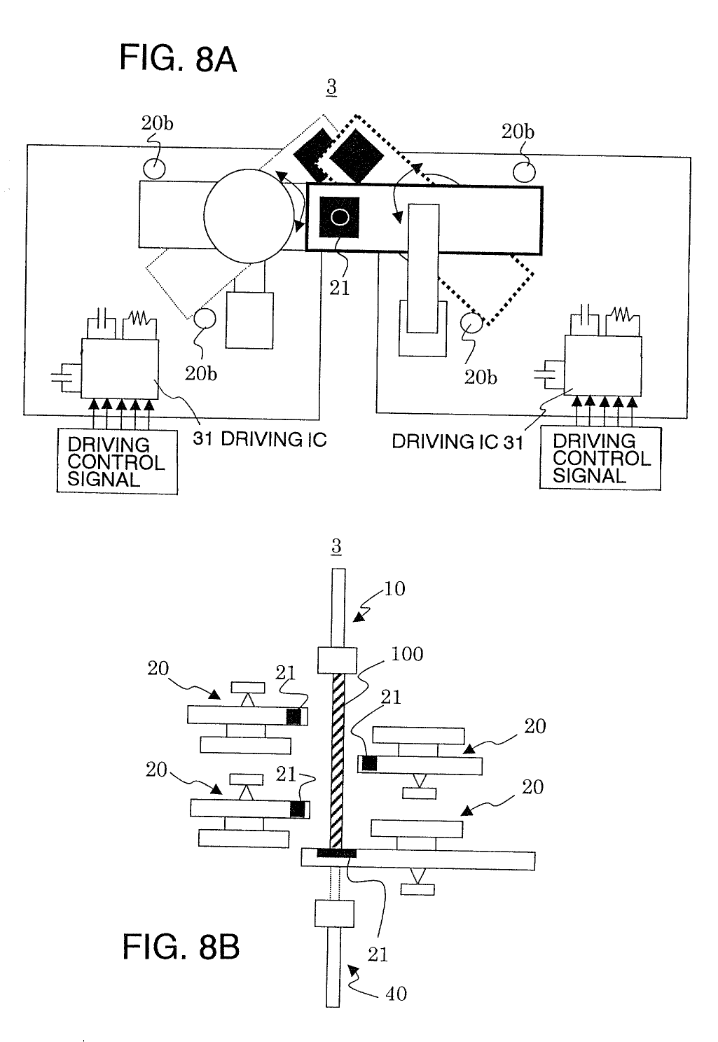

An optical communication device 3 in a fourth embodiment mode of the present invention schematically has a construction similar to that of the optical communication device 1. However, as shown in FIGS. 8A and 8B, a shutter for interrupting the light beam 100 is adopted as at least one optical part 21 (final one part in FIG. 8B).

In accordance with the optical communication device 3, the light beam 100 can be emitted and interrupted by setting the position of the optical part 21 as the shutter to the interrupting position of the light beam 100 and separating the position of the optical part 21 from the interrupting position. Namely, the optical communication device 2 becomes a device of a composite type also having the function of an optical switch while compactness is maintained.

Embodiment 5

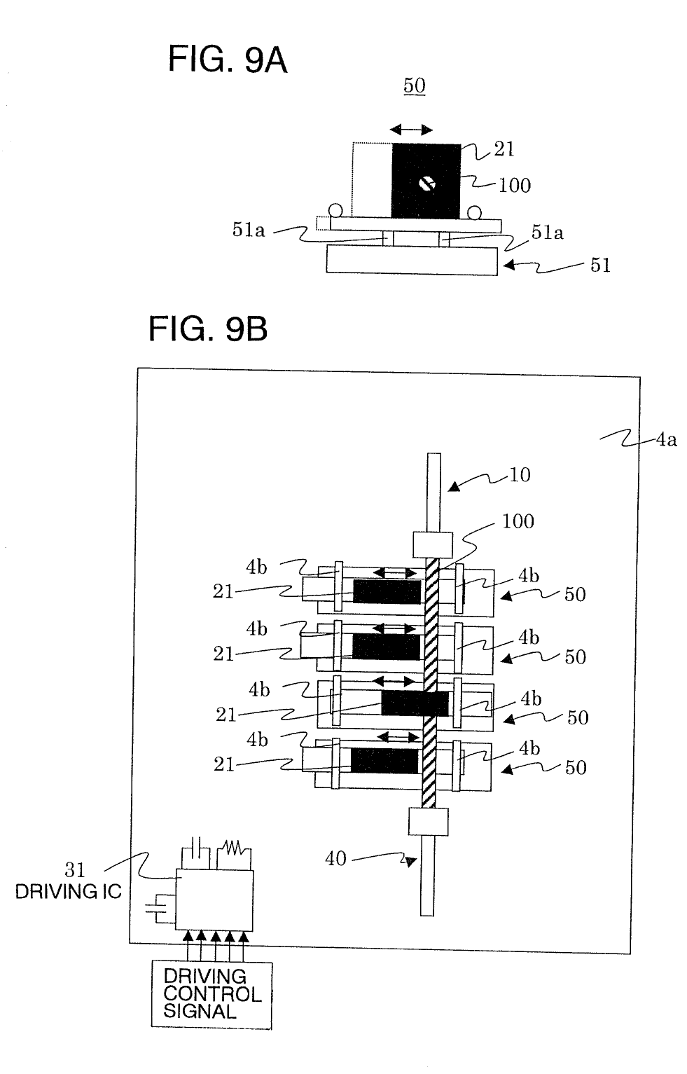

An optical communication device 4 in a fifth embodiment mode of the present invention schematically has the same construction as the optical communication devices 1 to 3. However, as shown in FIG. 9A, a moving optical member 50 is used instead of the moving optical member 20. Further, the driving circuit 31 is directly arranged on a substrate 4a of the optical communication device 4.

As shown in FIG. 9B, in the moving optical member 50, an optical part 21 is linearly moved by a piezoelectric actuator 51 of a direct acting type in a direction crossing the light beam 100.

The piezoelectric actuator 51 has a rectangular parallelepiped piezoelectric element and a vibrating body, and amplifies a bending vibration caused on an upper face of the above piezoelectric element by the above vibrating body, and outputs the bending vibration as driving force from a projection 51a on the vibrating body.

Here, the optical part 21 is nipped by two stopper members 4b rising on the substrate 4a and can be moved between these stop members 4b.

One stopper member 4b is positioned such that this stopper member 4b abuts on the optical part 21 when the optical part 21 is moved until the interrupting position of the light beam 100. The other stopper member 4b is positioned such that this stopper member 4b abuts on the optical part 21 when the optical part 21 is separated from the interrupting position of the light beam 100.

A preliminary signal provided by the control means 32 becomes a small driving signal in the optical communication devices 1 to 3, and a signal for driving the optical part 21 in an abutting direction on the stopper member 4b.

The optical part 21 is pressed against the above vibrating body by an unillustrated pressurizing means.

Namely, the optical communication device 4 obtains effects similar to those of the optical communication devices 1 to 3 by switching the optical part 21 arranged so as to interrupt the light beam 100 by driving the piezoelectric actuator 51.

The present invention is not limited to each of the above embodiment modes. In particular, there is no limit in an optical part applicable as the optical part 21 and its combination, etc. A compact optical communication device of a composite type (or a single function) having a predetermined desirable function is obtained by suitably selecting the optical part and its combination, etc.

It is not necessary to perfectly arrange each moving optical member 20 in series with the light beam 100, but it is sufficient to arrange each moving optical member 20 in a series direction within a range not departing from features of the present invention.

Further, a construction for obtaining a moving amount of each moving body, i.e., position information of the optical part from a consumed power amount and a driving direction of each piezoelectric actuator may be also used.

The optical communication device 1 in the second embodiment mode may have the projection 20b. In this case, the moving body 22d is positioned by the projection 20b, and the position of the moving body 22d is recognized by the encoder 23.

Further, each of concrete constructional elements, etc. can be suitably changed.

As mentioned above, in accordance with the present invention, the optical communication device can be made compact by arranging the optical part in series with the light beam. Further, a compact optical communication device of a composite type and an optical communication device having a backup function are obtained by suitably changing a combination of respective optical parts.

What is claimed is:

1. An optical communication device comprising:
an optical system for propagating a light beam through a space;
plural optical parts movable to an interrupting position of the light beam within the space, and arranged in a series direction with the light beam;
driving means for separately driving these optical parts; and
driving control means for controlling an operation of this driving means.

2. An optical communication device according to claim 1, wherein at least two kinds or more of optical parts are arranged as the optical parts.

3. An optical communication device according to claim 2, wherein two kinds or more of optical parts having different wavelength transmitting characteristics are included as the optical parts.

4. An optical communication device according to claim 2, wherein two kinds or more of optical parts having different wavelength absorption characteristics are included as the optical parts.

5. An optical communication device according to claim 2, wherein two kinds or more of optical parts having different transmitting light amount characteristics are included as the optical parts.

6. An optical communication device according to claim 2, wherein an optical part for interrupting light is included as the optical parts.

7. An optical communication device according to claim 1, wherein one or more optical parts having the same optical characteristics in at least one kind of optical parts are further arranged as the optical parts.

8. An optical communication device according to claim 1, wherein a plurality of the driving means are arranged, and the driving means located before and after the light beam are arranged between the same optical parts.

9. An optical communication device according to claim 8, wherein moving optical members provided by assembling the driving means into the optical parts are arranged in a zigzag shape such that the driving means is located between the same optical parts through the light beam.

10. An optical communication device according to claim 1, wherein the driving means is a piezoelectric actuator.

11. An optical communication device according to claim 10, wherein the piezoelectric actuator comprises a piezoelectric body for generating a stretching vibration, and a moving body frictionally driven by the stretching vibration generated in this piezoelectric body.

12. An optical communication device according to claim 10, wherein the piezoelectric actuator is of a rotating type.

13. An optical communication device according to claim 10, wherein the piezoelectric actuator is of a direct acting type.

14. An optical communication device according to claim 10, wherein the driving control means inputs a preliminary signal to the driving means before the driving.

15. An optical communication device according to claim 10, wherein the driving circuit has a self-excited oscillating circuit.

16. An optical communication device according claim 1, wherein a supporting member for movably supporting the optical parts is arranged, and at least one portion of the driving control means is arranged in this supporting member.

17. A control method of an optical communication device according to claim 1 in which plural optical parts are simultaneously driven.
